(19) United States
(12) Patent Application Publication
(10) Pub. No.: US 2015/0324715 A1
(43) Pub. Date: Nov. 12, 2015

(54) LOGISTICS SETTLEMENT RISK SCORING SYSTEM

(71) Applicants: JERALD SCOTT NELSON, SCOTTSDALE, AZ (US); ALAN DOUGLAS CHUTE, GILBERT, AZ (US); DAVID BARCLAY BRUCE HENDERSON, GALSTON (GB); ANTHONY LORON WOOTEN, CAVE CREEK, AZ (US)

(72) Inventors: JERALD SCOTT NELSON, SCOTTSDALE, AZ (US); ALAN DOUGLAS CHUTE, GILBERT, AZ (US); DAVID BARCLAY BRUCE HENDERSON, GALSTON (GB); ANTHONY LORON WOOTEN, CAVE CREEK, AZ (US)

(21) Appl. No.: 14/275,540

(22) Filed: May 12, 2014

(51) Int. Cl. G06Q 10/06; G06Q 10/08

(52) U.S. Cl. CPC G06Q 10/0635; G06Q 10/0838

(57) ABSTRACT

A method and system for measuring financial risk in logistics transactions is disclosed. Historical data from processing logistics transactions is reviewed with analysis tools to determine risk scores in key areas. The method may be updated for new components representing high risk in logistics and to refresh risk scores periodically. In embodiments, a module generates risk score results for a given client profile, which may include actual or estimated inputs for both activity levels and a control configuration. Control configuration inputs include not only the basic controls in place for risk mitigation, but also the data enhancements applied for every control as implemented by the client. The client data inputs originate from shippers, logistics service providers, financiers, auditors or other logistics ecosystem partners. The outputs include quantified risk score results in various formats, which may be accessed by computer, smart phone, tablet, mobile device, or via an Internet browser.

### FIELD OF THE INVENTION

The present invention in general relates to logistics, and in particular to a method and system for assessing logistics settlement risk.

### BACKGROUND OF THE INVENTION

Historically, settlement transactions for logistics services in the $4.2 trillion logistics industry contain many variables which result in complexity for both the buyer and seller of the services. High levels of risk are inherent in the logistics settlement process. That is, logistics services are complex service offerings with many constituent dimensions and valid configurations. Logistic settlement services can involve multiple parties with disparate technological systems, incompatible processes and inconsistent terminologies, spanning multiple geographies, languages, and currencies. Given this challenging trading environment, there is enormous potential for deficiencies to arise in the settlement process including errors, fraud and loss of opportunity. These process deficiencies typically result in sub-optimal performance outcomes for one or more of the involved stakeholders. Incorrect or insufficient processing of these transactions results in financial loss and incorrect financial reporting. Internal and external service solutions exist for the audit and processing of logistics settlement transactions, but these solutions only address a small percentage of the risks.

Furthermore, organizations often believe they have adequate controls in place to mitigate known risks in the processing and approval of logistics invoices. However, few executives understand the true risks in logistics settlement. No large-scale analysis of the main areas of risk and the financial quantification of the amounts at risk based on a control configuration is available. The typical process controls utilized focus on the recovery of amounts overcharged on invoices, but this approach is incomplete.

Studies show that up to 30% of all logistics invoices contain material deficiencies, and companies spend 7.5% of their revenue on average just for transportation. Any misclassification of this spending has a direct impact on the accuracy of financial statements. The Sarbanes-Oxley (“SOX”) law in the United States has made a company's management personally accountable for immediately addressing any material compliance gaps. The risk of paying for or spending money on duplicate invoices, services never received, invoices or freight bills for which the bill-to party is not responsible to pay, and incorrect or non-contracted charges for logistics activities is significant. Additionally, the risk of under-statements in financial reporting due to unbilled shipments or billings less than the contracted rates for logistics services is equally significant because it may undermine SOX compliance.

To mitigate the risk inherent in the logistics settlement process, it is necessary to institute detection and/or prevention controls to intercept the inevitable process deficiencies. As the logistics settlement process is a financial process, these controls can be characterized as financial controls. However existing key controls and external audits have surprising rates of failure in the logistics industry. The biggest impediment to automated, accurate, and complete measurement of risks in logistics is overcoming the poor quality of data available, combined with the need for a broad and extensive array of data for accuracy.

Automated tools are critical in logistics as the high volume of relatively low value transactions render controls based on manual human review both cost- and time-prohibitive. However, existing technical solutions, such as transportation management systems (TMS) or enterprise resource planning (ERP) systems, may only focus on one source of data—typically either shipment records or invoices—and may only cover a small subset of all transactions. External technical solutions may focus only on the minimum needed to process and pay an invoice. All systems assume the source data is perfect and meets minimum input requirements. No systems exist to fix bad source data. In the logistics industry, most transactions contain missing or invalid data elements necessary to quantify and mitigate financial risks. This measurement gap represents a major blind spot that is invisible to most stakeholders in the logistics ecosystem and causes significant undetected risk of over-spending and under-statement of financial obligations in today's logistics settlement environment.

Financiers have created significant business opportunities in the financing of receivables for goods and services of all kinds. The methods for measuring credit risk based on the value of physical goods received and safely housed and the propensity of buyers to pay their obligations on time are well understood and established. However, the financing of outstanding receivables in the market for logistics services has been largely untapped by financiers because of the difficulty in assessing the risk of an obligation for payment. This is largely related to the bad data and the lack of standard systemic methods for measuring the financial risk of logistics settlement transactions.

In the wake of this confusion and complexity, shippers, financiers and logistics service providers (LSPs) need a clear and concise measurement of financial risks. Shippers need a way for any organization to calculate the value of financial deficiencies at risk in spending and financial reporting for the cost of logistics activities. Financiers need an independent measure of financial risk to assess the quality of any logistics payable or receivable transaction for financing purposes. LSPs need a way to calculate the value of financial deficiencies at risk in their receivables transactions for ensuring the integrity, timing, cost and efficiency of revenue collections. This measurement of risk must incorporate sophisticated tools for fixing the bad data that permeates the logistics industry and undermines the accurate recognition of financial risks.

Thus there exists a need for sophisticated tools that are able to detect and correct bad source data for improved visibility to factors contributing to financial risks for shippers, financiers and logistics service providers, while also providing a comprehensive analysis of projected financial risk using risk factors based on the historical occurrence of each type of risk applied to the logistics settlement profile for an organization.

### SUMMARY OF THE INVENTION

A method and system for assessing logistics settlement risk is provided. According to an embodiment, a logistics settlement risk scoring system may include an application integration and communication layer to interface with one or more data sources over a network to receive logistics settlement data. The system may include a data repository to store model building data sets determined from the settlement data. The system may include a profile collector to capture the scenario to be tested. This profile may include information about logistics activity levels and the logistics settlement financial control configuration for a client (shipper, logistics services provider (LSP) or financier) or group of clients. The profile may be estimated and captured via a client interview or collected in real-time through the application integration and communication layer from the logistics settlement execution system. The system may include a risk component (predictive variable) identifier to determine the causal risk factors to include in the risk models and a model generator module, which may be executed by a processor, to determine the logistics settlement scoring models from the model building data sets and to store the logistics settlement scoring models in the data repository. The logistics settlement risk scoring models may include a duplicate billing risk scoring model, a non-company liability risk scoring model, a service validation risk scoring model, a charge validation risk scoring model, a contract coverage risk scoring model, and a shipper payment propensity risk scoring model as well as other risk scoring models.

Embodiments of the system may also include a logistics settlement risk analysis module, which may be executed by the processor, to determine the overall settlement risk of the input scenario for each stakeholder in the logistics settlement ecosystem. This overall risk includes the shipper's invoice settlement and understated obligations risk, the logistics service provider's collectability and understated billing risk and the financier's credit risk to finance the subject invoices. The system may include a dashboard comprised of a graphical user interface (GUI) to provide an aggregated view of logistics settlement risk for shippers, LSPs and financiers and illustrations of duplicate billing risk, non-company liability risk, service validation risk, charge validation risk, contract coverage risk, and shipper payment propensity risk as well as other types of risk. These dashboard views are entry points into the logistic settlement optimization system's general reporting and ad hoc analytics capabilities.

In a preferred embodiment, the application integration and communication layer may be implemented as an application programming interface (API) in an application platform environment. In this embodiment the data repository is a dedicated database system. The profile collector module, risk component identifier module, risk model generator module, risk analysis module and dashboard module are all implemented as application modules in a generalized application platform environment. This embodiment can be implemented on many forms of computation devices including desktop computers, internet-based systems, mini/mainframe systems, tablets and smart phones.

In another embodiment, the application integration and communication layer may be implemented as an application programming interface (API) in an application platform environment. The data repository is a dedicated database system. The profile collector module, risk analysis module and dashboard module are all implemented as applications in a generalized application platform environment. In this embodiment, the risk component identifier module is realized through analysis of the historical data in the data repository. In addition, the risk scoring models are developed through analysis. This embodiment can be implemented on many forms of computation devices including desktop computers, internet-based systems, mini/mainframe systems, tablets and smart phones.

In another embodiment, the logistics settlement risk scoring system may be implemented in an integrated spreadsheet model. The data repository is realized as data embedded in a spreadsheet application file. The client profile input data is collected via an interview with the client or examination of historical data to answer questions presented in a spreadsheet application worksheet. In this embodiment, the risk component identifier module is realized through analysis of the historical data in the data repository. In addition, the risk scoring models are developed through additional analysis and represented in a spreadsheet application worksheet. The dashboard module is represented as a reporting framework implemented in a spreadsheet application worksheet. The application integration and communication layer module is manifest through the application programming interface (API) native to the spreadsheet application program. This embodiment can be implemented on many forms of computation devices including desktop computers, internet-based systems, mini/mainframe systems, tablets and smart phones. The risk component and aggregation algorithms are executed by the application of formulas and routines within the integrated spreadsheet model.

These and other features of the present invention will be described in more detail below in the detailed description of the invention and in conjunction with the following figures.

### BRIEF DESCRIPTION OF THE DRAWINGS

The present invention is further detailed with respect to the following drawings. These figures are not intended to limit the scope of the present invention but rather illustrate certain attributes thereof in which like reference numerals indicate similar elements.

FIG. 1 illustrates a block diagram of a system architecture of a logistics settlement system according to an embodiment of the invention;

FIG. 2 illustrates a block diagram of a logistics settlement risk scoring system in accordance with embodiments of the present invention;

FIG. 3 is a schematic diagram illustrating an overall view of communication devices, computing devices, and mediums for implementing embodiments of the logistics settlement risk scoring system of FIG. 2;

FIGS. 4 and 5 illustrate flow charts of methods that may be performed by the logistics settlement risk scoring or other systems in accordance with embodiments of the present invention;

FIG. 6 is a schematic diagram that shows a set of input sources for the calculation of the logistic settlement risk score in accordance with an embodiment of the present invention;

FIG. 7 shows the application of a calculated logistic settlement risk score to a client logistics settlement profile according to an embodiment of the invention;

FIG. 8 is a table showing the application of a calculated logistics settlement risk score to transportation invoices grouped by LSP according to an embodiment of the invention;

FIG. 9 is a table showing the application of a calculated logistics settlement risk score to individual invoices according to an embodiment of the invention; and

FIG. 10 is a table showing a lower level detail of the ‘duplicate’ risk area with details of risk in each sub-area according to an embodiment of the invention.

### DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

The present invention has utility as a method and system for assessing logistic settlement risk. Embodiments of the invention provide sophisticated analytical tools that are able to detect and correct bad source data for improved visibility to factors contributing to financial risks for shippers, financiers and logistics service providers, while also providing a comprehensive analysis of projected financial risk using risk factors based on the historical occurrence of each type of risk applied to the logistics settlement profile for an organization.

Embodiments of the invention analyze historical logistics related data to identify the risk components that contribute to logistics settlement risk and capture the various correlation coefficients for each risk component. The identified risk components and their correlation coefficients are compiled into scoring models that are utilized to classify projected or actual logistics spend (a shipper's expenditure on logistics services) into approved charge and deficient charge categories. The deficient charges may represent logistics billing errors, abuse, fraud or sub-optimal charges from a cost management perspective. The risk components also cover under-statements such as unbilled shipments, which may misstate financial liabilities until they appear in a future accounting period.

Embodiments of the invention provide a system that evaluates projected or actual logistics spend represented as a flow of invoices through the settlement process. An invoice is a request for payment for a product or service rendered. Invoice processing involves handling an incoming invoice from the point of receipt, through the posting of the accounting entries to the final payment of the obligation. This process, also known as the purchase-to-pay process, can be automated with computer technology. Invoice processing automation or e-invoicing is a generalized process that is applicable to all vertical industries. However, for certain industries such as telecommunications and logistics, the process is highly specialized and sophisticated owing to the unique and complex nature of the product (service) offering.

A typical logistics settlement process begins with the exchange of a transportation order from a buyer to a seller of logistics services. Settlement transaction documents such as invoices, orders, and goods receipts are delivered through one of multiple paper or electronic means. Paper documents are converted to electronic form. The content of each transaction document is parsed into its constituent components. These components are normalized (converted into a common, standard form) for comparison purposes, and the various transaction documents are reconciled. The settlement transaction is then classified for accounting purposes and finally paid. These functions can be thought of as automated logistics settlement processing. In addition, because there is a significant risk of erroneous, fraudulent or sub-optimal charges being presented, there is a need for a risk management or audit function. These risks may include shipments that have not yet been billed. This risk management function can be performed manually or, as in the case of the settlement processing, automated. Because logistics settlement is a financial process, the mechanisms designed to mitigate risk in the process can be viewed as financial controls. These financial controls are employed to intercept deficient charges as settlement transactions are processed. The historical data accumulated during this risk management process is utilized to generate scoring models. The generated scoring models are applied to one or more client logistics settlement profiles to derive projected logistics settlement risk for shippers, LSPs and financiers due to inadequate financial controls.

There are various scenarios within which embodiments of a logistics settlement risk scoring system can be deployed. For example, the risk scoring system can be applied in a scenario where the logistics settlement profile, including the characteristics of logistics spend and control configuration, are estimated by the client. Of course, the quality of the risk score projection would depend upon the quality of the estimated profile information provided. In an alternative scenario, rather than collecting an estimated input profile from the client, where the client is utilizing the operational invoice processing and risk management capabilities of the logistics settlement execution system, the risk system produces a risk score projection based upon the real-time profile information collected from the operational system. In addition to allowing the scoring of real-time invoice data from the operational system, embodiments of the risk scoring system will allow the scope of the profile to be adjusted. That is, the set of invoices targeted for scoring can be adjusted from very large sets based on various filtering attributes down to very small collections including individual invoices.

Embodiments of the inventive logistics settlement risk scoring system may be used to provide an organization with visibility into their exposure to uncontrolled risk due to deficient logistics invoices and invoicing processes with a risk score report. The risk score report provides detail that allows those reviewing their logistics settlement process to understand the factors or metrics contributing to their uncontrolled risk and suggests the corrective actions necessary to mitigate the risk. In addition, as these metrics are tracked over time, trends can be monitored to understand the direction and effectiveness of an organization's mitigation strategies.

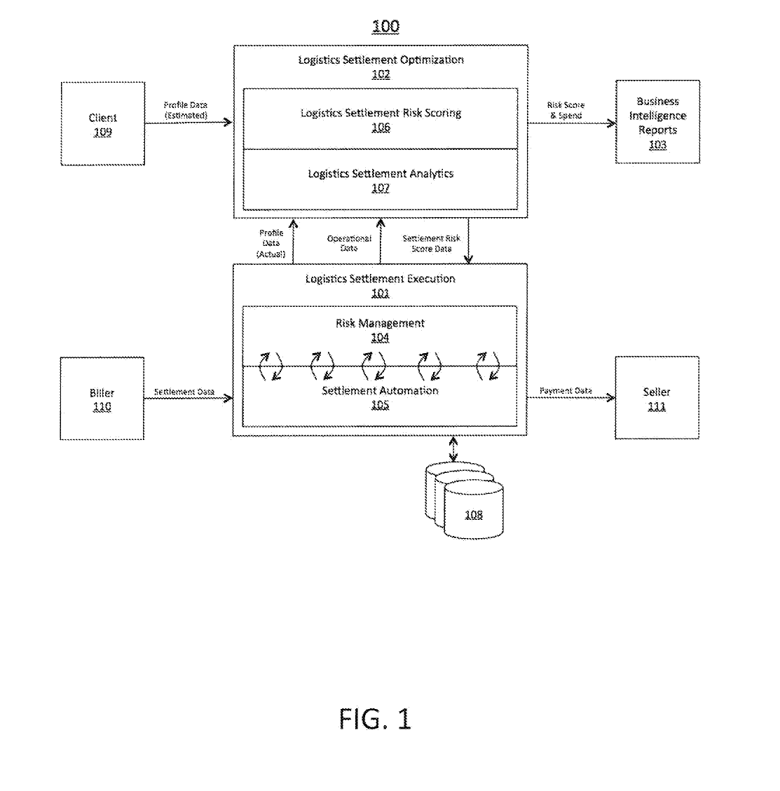

Referring now to the figures, FIG. 1 illustrates a logistics settlement system 100, according to an embodiment of the invention. The system 100 includes a logistics settlement execution system 101 and data sources 108 that provide data to the logistics settlement risk execution system 101. The data sources 108 are represented as outside data sources, but may also include data sources that are internal to the system 100, such as an internal data repository that stores logistics settlement activity over time. The logistics settlement execution system 101 is composed of the settlement automation system (e-invoicing, e-billing) 105 and the risk management (audit) system 104. The settlement automation system 105 manages the workflow process of capturing paper or electronic shipment information from a billing party 110, allocating the cost in the accounting system and submitting a payment back to an invoice selling party 111. The risk management system 104 applies financial controls to detect and intercept erroneous, fraudulent or sub-optimal logistics charges as well as under-statements, such as unbilled shipments, which may misstate financial liabilities until they appear in a future accounting period.

Continuing with FIG. 1, a logistics settlement optimization system 102 includes a logistics settlement analytics system 107 and a logistics settlement risk scoring system 106. The logistics settlement analytics system 107 provides capabilities, applicable to the entire logistics settlement process, for reporting (static and dynamic) and general ad hoc analysis via online analytical processing (OLAP) of logistics settlement data. OLAP tools enable users to analyze multidimensional data interactively from multiple perspectives. The logistics settlement risk scoring system 106 produces one or more scoring models and utilizes these models to classify the risk of incoming batches of invoices in a logistics settlement profile. These batches can be from “live data” that is derived from the logistics settlement execution system 101, or from an estimate provided through an interview with a client organization 109. The logistics settlement risk scoring system 106 may interface with the logistics settlement execution system 101 over a network, which may include the Internet, to receive settlement data. Settlement data includes any data that may be used for generating the scoring models and evaluating incoming batches of invoices.

Furthermore, business rules, logistic regression, and scoring criteria may be used for developing scoring models and/or scoring invoices. Business rules abstract the business logic of financial controls away from the code level so that they can be easily modified as the business environment changes and can be executed by a specialized rules engine. The output of the logistics settlement risk scoring system 106 may include scoring models, invoice risk score data identifying scores for invoices and business intelligence metrics. The scores and metrics may be displayed via a dashboard and/or provided to the logistics settlement execution system 101 and/or delivered by report or message to external users or systems 103.

In embodiments, scores and metrics provided to the logistics settlement execution system 101 may eventually be used to create or update scoring models or used for additional analytics. The scores may be comprised of elements related to multiple facets of the logistics settlement activity. The metrics may indicate where and what items are high risk and suggest corrective actions. The metrics may be included in periodic reporting to the client or other external user 103. The metrics may be used to identify trends that warrant further analysis, such as whether particular geographies, shipping modes, or service providers are associated with an unusually high number of high-risk invoices. Risk Scores assigned to an individual invoice may also be used as an indicator of financial strength in a receivables financing transaction.

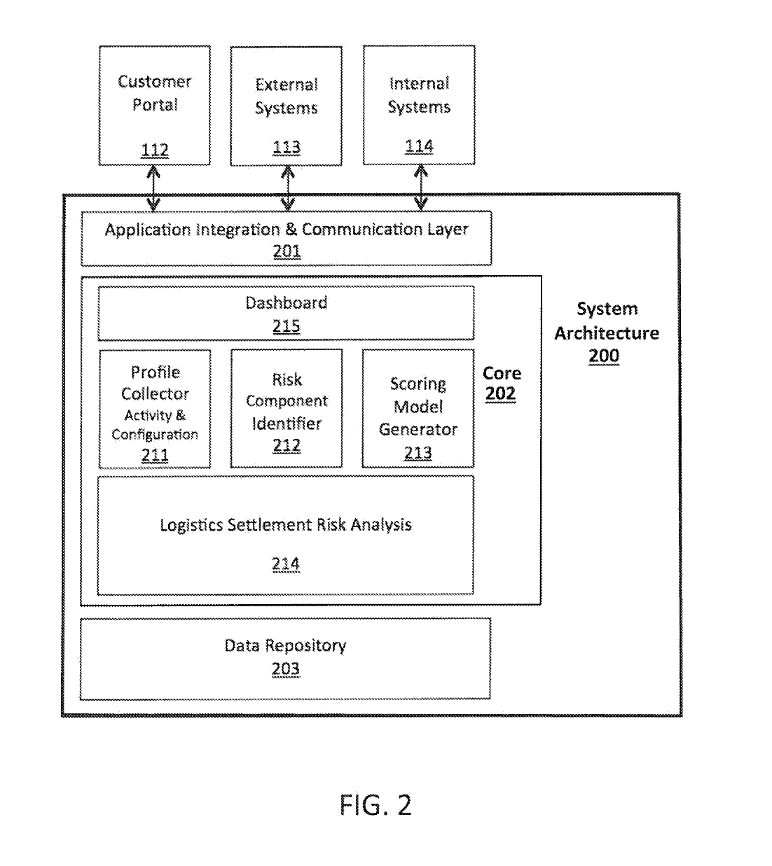

FIG. 2 illustrates an expanded system architecture 200 for the logistics settlement risk scoring system that is represented as module 106 in FIG. 1. This system includes an application service integration and communication layer 201, a core 202, and a data repository 203 including data structures for storing logistics settlement data on one or more storage devices. The application service integration and communication layer 201 supports data collection from internal systems 114 of the system user, which may include enterprise applications such as ERP, TMS, SAS, etc. The internal systems 114 may be part of the data sources 108. The layer 201 may also provide secured access with user/customer portals 112 and external third party portals and systems 113. Generally, the layer 201 provides a mechanism for interfacing with the different systems and web interfaces.

The layer 201 provides data collection from enterprise resources and other sources in the internal systems 114. The layer 201 may include application program interfaces (APIs) to communicate with the internal systems 114. For example, the layer 201 receives data from the enterprise applications through APIs or other interfaces and may normalize the data for storage in the data repository 203. Normalizing may include formatting according to predetermined schemas. The layer 201 maps the received data to schemas of data structures, which may include tables in the data repository 203. The data repository 203 may include a database using the tables. Some of the information stored in the data repository 203 may include logistics settlement data, which may be gathered from the data sources 108, which may be internal or external. The stored information may include model building data sets and validation data sets, which may be determined from the logistics settlement data or other data received at the logistics settlement risk scoring system 106. Other stored information may include scoring models generated by the logistics settlement risk scoring system 106, business rules for the financial controls, logistics spend levels, control configuration data, and score aggregation algorithms.

The core 202 performs the functions of the logistics settlement risk scoring system 106. The core 202 may perform the methods described in detail below including processes for model building and invoice batch evaluation. The core 202 may include a profile collector module 211, a risk component identifier module 212, a model generator module 213, a logistics settlement risk analysis module 214, and a dashboard 215. The risk component identifier module 212 identifies characteristics of the logistics settlement process that correlate to settlement risk. Statistical analysis techniques such as cross-tab analysis, factor/cluster analysis and principal component analysis (PCA), multiple regression, and analysis of variance/analysis of covariance (ANOVA/ANCOVA) may be used to identify these risk components. Machine learning techniques, such as multi-dimensional polymorphism and quantum state machines, may also be utilized to identify risk components. The risk components may include variables for generating the models including variables related to duplicate billing risk, non-company liability risk, service validation risk, charge validation risk, contract coverage risk, and shipper payment propensity risk, as well as other risk areas.

Continuing with FIG. 2, the model generator module 213 generates the risk scoring models. Scoring models may be generated for different risk areas. The models may be generated using statistical analysis techniques such as logistic regression, business rules, or other model building techniques based on the derived risk components and other variables. Information for the variables may be received from the data sources 108. In one example, logistic regression is performed by a processor to build a multivariate model. For example, risk components, i.e. predictive variables are selected and a model is generated using the components. A component is removed and the model is refitted to determine if the new model is stronger than the old model. If so, the component is considered important and is kept. This process is repeated until the components are determined for the model.

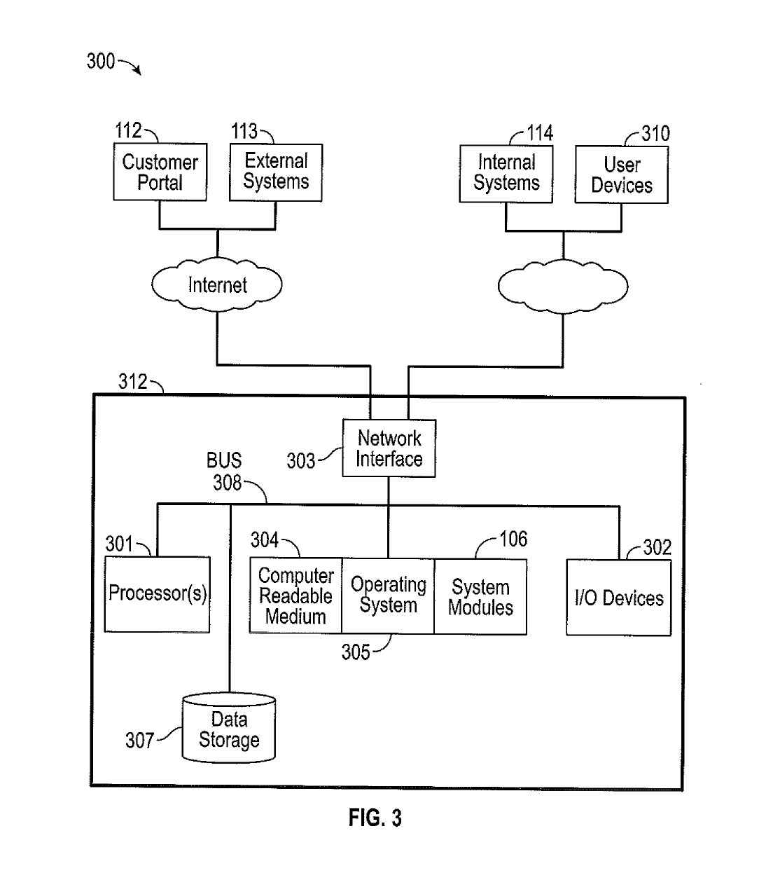

The dashboard 215 may present information related to the logistics settlement risk evaluation. For example, the logistics settlement risk analysis module 214 evaluates the invoice batch(es) for a client based on the scoring models. Evaluation results and metrics may be presented via the dashboard 215. The dashboard 215 may comprise a graphical user interface (GUI) presented on a computer screen. The computer screen may be a display provided as an input/output device in the computer system 300 described in FIG. 3. The dashboard 215 may provide graphical illustrations of logistics settlement risk including invoice settlement risk and understated obligations risk. In a specific embodiment, the dashboard 215 may be generated by a Web browser. In addition, the dashboard 215 presents information for each invoice batch. Using the dashboard 215, the invoice batch is selectable for drill downs, all the way to the individual invoice or shipment level; to display additional information describing the risk profile, spend at risk, root causes, and corrective actions.

FIG. 3 is a schematic diagram 300 illustrating an overall view of communication devices, computing devices, and mediums for implementing the logistics settlement risk scoring system 106 according to embodiments of the invention. The elements of the embodiments of FIGS. 1 and 2 are included in the networks and devices of FIG. 3. It is understood that the illustration of the system 300 is a generalized illustration, and that the system 300 may include additional components and that some of the components described may be removed and/or modified. In specific embodiments, the logistics settlement risk scoring system 106 may be implemented in a distributed computing system, such as a cloud computer system. For example, the computer system 312 may represent a server that runs the logistics settlement risk scoring system 106, or the computer system 312 may comprise one of multiple distributed servers that perform functions of the logistics settlement risk scoring system 106.

Embodiments of the computer system 312 include one or more processors 301, such as a central processing unit (CPU), application-specific integrated circuit (ASIC), or other type of processing circuit; input/output (I/O) devices 302, such as a display, mouse, keyboard, touch screen, etc.; a network interface 303, such as one or more interfaces for connecting to a network 314 such as a local area network (LAN), a wireless 802.11x LAN, a 3G or 4G mobile wide area network (WAN) or a WiMax WAN, or other type of network; and a computer readable medium 304. Each of these components may be operatively coupled to a bus 308. The computer readable medium 304 may be any suitable medium that participates in providing instructions to the one or more processors 301 for execution. For example, the computer readable medium 304 may be non-transitory or non-volatile media, such as a magnetic disk or solid-state non-volatile memory or volatile media such as random access memory (RAM). The instructions stored on the computer readable medium 304 may include machine-readable instructions executed by the one or more processors 301 to perform the methods and functions of the logistics settlement risk scoring system 106. The computer readable medium 304 may store an operating system 305, such as MAC OS, MS WINDOWS, UNIX, LINUX, Apple iOS, or Google Android and one or more applications, which include the modules for the logistics settlement risk scoring system 106, such as shown in core 202 of FIG. 2. The operating system 305 may be multi-user, multi-processing, multi-tasking, multi-threading, real-time, etc.

Embodiments of the computer system 312 may include a data storage component 307, which may include non-volatile data storage. The data storage 307 stores any data used by the logistics settlement risk scoring system 106. The data storage 307 may be used for the data repository 203 shown in FIG. 2, or the computer system 312 may be connected to a database server (not shown) hosting the data repository 203.

The network interface 303 connects the computer system 312 to the internal systems 114 via the network 314, for example via a LAN. End user devices 310 and other computer systems/servers may connect to the computer system 312 via the network interface 303. In a specific embodiment, the network interface 303 may connect the computer system 312 to the Internet 316. For example, the computer system 312 may connect to customer portals 112 and external systems 113 via the network interface 303 and the Internet 316.

As noted there are high levels of inherent risk in the logistics settlement process. To mitigate the risk inherent in the logistics settlement process, it is necessary to institute detection and/or prevention controls to intercept the inevitable process deficiencies. As the logistics settlement process is a financial process, these controls can be characterized as financial controls. In embodiments of the invention, financial controls are employed in the execution system's risk management sub-system 104. Due to the inverse relationship between the risk remaining in the logistics settlement process and the measure of financial control exercised, any method for predicting an organization's residual settlement risk will necessarily assess the effectiveness of the financial controls that the organization employs. Each correlation coefficient defining a specific combination of predictive and predicted variables is assigned to represent a specific inherent risk component. Embodiments of the model recognize controls that are deployed to mitigate each specific risk component. Each control identified is represented in the model by an entry in a control taxonomy with a unique control code, which is described as follows:

| | |
|---|---|
| Control Code: | XX-XX-XX-XX-XX-XX |

1 2 3 4 5 6

1 - Risk Type
The Type of Risk - e.g., Duplicate, Liability, Service, Charge, Contract
2 - Risk Object
The Object of Risk - e.g., Invoice, Shipment, Charge
3 - Test
The unique test represented by an algorithm applied to a specific Risk Type & Object
4 - Strength Level
The relative strength level of this test within a given Risk Type & Object
5 - Spend Segment
The subset of total transactions to which this Control applies
e.g., All Ocean shipments
6 - Data Source
The source of data for transactions to which this Control applies
e.g., Invoices from Trax's database matched to RFTs from Shipper systems

The relationship between logistics settlement risk and the measure of financial control exercised can be expressed more precisely by the following mathematical formula:

Inherent Risk_{Profile}=Control Effectiveness_{Profile}+Control Risk_{Profile} (Eq. 1)

or

Control Risk_{Profile}=Inherent Risk_{Profile}−Control Effectiveness_{Profile} (Eq. 2)

Where inherent risk is the risk natively present in the scenario environment before risk mitigation measures are applied. Control effectiveness is a measure of the risk that is successfully mitigated by the subject control(s). Control risk is the residual risk remaining after the control(s) has been applied.

However, inherent risk is notoriously difficult to capture, measure, and quantify. In the logistics settlement domain, inherent risk represents the actual overstatement and understatement risk for each stakeholder. Given the complexity of the trading environment settlement deficiencies are pervasive. Thus, even if highly qualified logistics personnel rigorously and consistently examine every charge within every shipment on every invoice, it is unlikely that they will capture all deficiencies present in the process. Furthermore, the approach is extremely labor intensive and creates a high cost-benefit ratio that makes it prohibitive to pursue such an approach. Given that all known controls are applied in the (optimal) model training scenario, and new approaches to improve the efficacy of the risk controls will continuously be sought, control effectiveness can serve as a reasonable proxy for, and is a conservative estimate of, inherent risk in the model training scenario.

In this scenario every control that is practically available may be applied. Stated another way, in the optimal training scenario, where maximum available controls are applied, the residual control risk should be minimal. Mathematically this is expressed as follows.

Inherent Risk_{Training}=Control Effectiveness_{Training}+Control Risk_{Training} (Eq. 3)

or

Control Effectiveness_{Training}=Inherent Risk_{Training}−Control Risk_{Training} (Eq. 4)

Furthermore, in a training scenario where control effectiveness is very high compared to the control risk an approximation can be made as follows:

Control Effectiveness_{Training}≈Inherent Risk_{Training} (Eq. 5)

Also, since inherent risk is the same for each risk component in all evaluation scenarios, including training and profile then:

Inherent Risk_{Profile}=Inherent Risk_{Training} (Eq. 6)

and therefore:

Inherent Risk_{Profile}=Control Effectiveness_{Training} (Eq. 7)

Therefore, the control effectiveness for the training scenario may be used as a reasonable approximation of the inherent risk for a profile scenario when computing the residual control risk for an evaluation (profile) scenario as follows:

Control Risk_{Profile}=Inherent Risk_{Profile}−Control Effectiveness_{Profile} (Eq. 8)

or

Control Risk_{Profile}=Control Effectiveness_{Training}−Control Effectiveness_{Profile} (Eq. 9)

However, logistic settlement risk is not monolithic, that is, the risk encountered in the logistic settlement process is of multiple, distinct types and derives from various source deficiencies. Therefore, the total control risk remaining in the logistics settlement process is an aggregate measure of the control risk for several sub-risks known as risk components (rc). The simplest aggregation technique for these risk components would be an algebraic sum as follows:

$$Total Control Risk \neq {\sum }_{rc = 1}^{n} Control {Risk}_{rc} \qquad ( EQ . 10 )$$

However, this aggregation technique would only apply if the various risk components were disjointed sets, which they are not. A key fact to recognize is that logistics settlement risk and control efficiency measures are ratios that represent groups or sets. These sets contain the numerous logistics charges (and associated spend) that either pass or fail particular control tests. In addition, it should be noted that logistics settlement financial controls are arrayed in layers with the most generalized and cost effective controls at the first (outermost) layer and the more specialized and expensive controls following later. As a result, any given logistics charge may trigger multiple financial controls as it passes through the settlement process. However, each charge has the potential to be misappropriated only once, and therefore can only be counted once when aggregating the overall risk score. Therefore, the appropriate aggregation method to use when tallying control risk is the mathematical union of control risk, by risk component. This technique will capture each charge (and its associated spend) once and only once as follows:

$$\begin{matrix}Total Control Risk = Control {Risk}_{1} ⋃ Control {Risk}_{2} ⋃ … Control {Risk}_{n} = {⋃}_{rc = 1}^{n} Control {Risk}_{rc} \\ or & ( EQ . 11 ) \\ {⋃}_{rc = 1}^{n} Control {Risk}_{rc} = {⋃}_{rc = 1}^{n} {( \begin{matrix}Control {Effectiveness}_{Training} - \\ Control {Effectiveness}_{Profile}\end{matrix} )}_{rc} & ( EQ . 12 )\end{matrix}$$

Decomposing control effectiveness further, the effectiveness of a control is enabled by the quality of the control design and also by the care with which the control is implemented as follows:

Control Effectiveness=Control Design Effectiveness*Control Implementation Effectiveness (Eq. 13)

Of course, it is important that a control is designed properly to support its intended purpose. However, the most optimally designed control will fail unless it is implemented correctly. For an automated financial control to function properly, the control must receive input data in a form that is suitable for processing. These input data requirements can take many forms but must in all cases be satisfied via the application of appropriate data enhancers in order to enable an effective control. In addition to input data, a financial control often requires reference data for comparison purposes when executing a test algorithm. For example, currency or mileage calculations will refer to external reference data sources for this supporting data. Without this required reference data the control will not be effective. Finally, a financial control can only be effective if it is implemented consistently. Thus, it is critical, when assessing logistics settlement risk, to determine if a control that is ostensibly in force is actually being consistently applied. Thus, embodiments of the scoring model take into account all of these criteria when calculating predicted risk scores.

Control Implementation Effectiveness=Control Input Quality*Control Reference Quality*Control Application Consistency (Eq.14)

and therefore

Control Effectiveness=Design Effectiveness*(Input Quality*Reference Data Quality*Application Consistency) (Eq. 15)

Furthermore, in addition to merging and de-duplicating the control risk, embodiments of the model building method allocate the remaining control risk (after de-duplication) to the first (outermost) control that is triggered, where the risk would be most cost effectively mitigated. That is, there is a precedence order for the allocation of risk to controls. An embodiment of a hierarchy of risk allocation precedence is illustrated as follows:

| | |
|---|---|
| 1. | Billing Duplication |
| | 1.1. Invoice Duplicate |

1.1.1. Test 1: Primary Test

1.1.1.1. 1^{st} Strength Invoice Duplicate Strength Level

1.1.1.1.1. Spend Segment 1
1.1.1.1.2. Spend Segment 2

1.1.1.2. 2^{nd} Strength Invoice Duplicate Strength Level

1.1.1.2.1. Spend Segment 1
1.1.1.2.2. Spend Segment 2
1.1.1.2.3. Spend Segment 3

1.1.1.3. 3^{rd} Strength Invoice Duplicate Strength Level

1.1.2. Test 2: Proxy 1 Test

```
  1.1.2.1. 1^{st} Strength Invoice Duplicate Strength Level
  1.1.2.2. 2^{nd} Strength Invoice Duplicate Strength Level
  1.1.2.3. 3^{rd} Strength Invoice Duplicate Strength Level
```

1.1.3. Test 3: Proxy 2 Test

```
  1.1.3.1. 1^{st} Strength Invoice Duplicate Strength Level
  1.1.3.2. 2^{nd} Strength Invoice Duplicate Strength Level
  1.1.3.3. 3^{rd} Strength invoice Duplicate Strength Level
```

| | |
|---|---|
| | 1.2. Shipment Duplicate |
| | 1.3. Charge Duplicate |
| 2. | Non-Company Liability |
| 3. | Service Verification |
| 4. | Charge Validation |
| 5. | Contract Coverage |

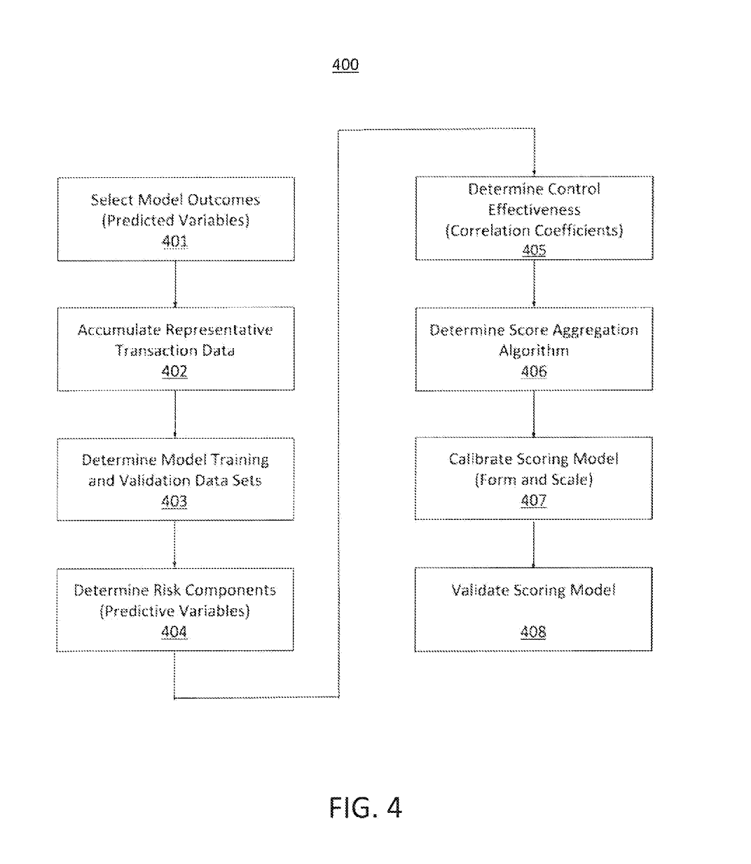

FIG. 4 illustrates a method 400 according to an embodiment for generating accurate and precise risk scoring models to predict risk in the logistics settlement process for the various stakeholders. The method 400 includes analysis of empirical historical information gathered in a database and converts this information into risk components and correlation coefficients in a risk scoring table that can be applied to a logistics settlement risk profile to determine the logistics settlement risk score and monetary risk value represented. The method 400 and other methods and functions described herein may be performed by the system 106 shown in FIGS. 1 and 2 by way of example. The methods may be performed in other systems as well.

At 401, selected model outcomes (predicted variables) representing high-risk in logistics transactions are identified. Specific occurrences of these model outcomes are stored in a database along with the timeframe of transaction activity. These variables may be related to risk components in the scoring models to determine the control effectiveness correlation coefficients used in calculating the risk associated with a given logistics settlement profile. These model outcomes include over-reporting (e.g., invoice settlement) and under-reporting (e.g., understated obligations) types of risk. In addition, the model outcomes will include aggregate risk measures for multiple stakeholder groups in the logistics settlement ecosystem including shippers, logistics service providers and financiers.

At 402, actual settlement transactions are accumulated from empirical, historical data stored in a database. Data normalization may be applied using a computer system to develop a sound data foundation for determining risk components and correlation coefficients. The data utilized for training and validation data sets is captured at this stage.

At 403, model-building data sets for training and validating the risk components and correlation coefficients are determined from historical logistics transaction data. It is important to collect logistics transactions from a wide variety of shippers, logistics service providers and financiers operating in every global region to ensure an aggregate representation of transactions containing a full spectrum of risk profiles. A large, representative data set should be collected to ensure precise initial training of the scoring model. In addition, an equally representative data set should be held aside to conduct an independent validation test of the scoring model's tuning.

At 404, selected risk components (predictive variables) representing a high-risk in logistics transactions are identified for incorporation into scoring model(s). The identification of these risk components may be accomplished using audits performed through a computer system and/or using expert human analysis. Advanced analytics techniques are used to generate these scoring models. For example, logistic regression, machine learning techniques, such as multi-dimensional polymorphism and quantum state machines, decision trees, “data mining” regression, bootstrapping, and ensemble (a method that combines the predictions from the individual models) are techniques used to identify the risk components that predict financial risk in logistics settlement activity. These risk components are then incorporated into predictive scoring models that may be applied to a logistics settlement profile to project a logistics settlement risk score and monetary risk value.

For example, one factor that might indicate financial risk associated with a logistics settlement transaction would be an invoice that has been approved without comparing the service level requested with the service level billed on the invoice. This risk component may be derived by combining data from the organization's transportation management system (as represented by a request for transportation (RFT) message) showing service requested with empirical historical data from the invoice showing service billed after normalizing for differences in nomenclature describing service levels to enable comparison by a computer system. Risk components may be applicable to all transactions or only a subset of transactions within which the model outcomes representing high-risk are known to be relevant.

At 405, the risk component data is used in an advanced analytic process to build the correlation coefficients representing control effectiveness. The risk components and correlation coefficients fill out the scoring models that are applied to a client profile to predict their logistics settlement risk. When the models are complete, the models can then be adjusted based on review of any risk values determined to be outliers. Data or process characteristics in the underlying source data may overstate certain risks because the data used to determine the risk is not deemed to be representative of the whole population, including those that might not represent factors that are truly high-risk (false positives). The software tools allow the user/model builder to update the correlation coefficients to reflect the results of expert human analysis. The scoring model will also include an ability to enter externally reported inherent risks that will not be considered in the application of the model. These externally reported inherent risks may include results from post audits, random sample checking, and unsolicited inputs, etc.

Multiple scoring models may be generated at 405 to accommodate different areas of risk. For example, a duplicate billing risk scoring model, a non-company liability risk scoring model and a charge validation risk scoring model may be generated from an invoice risk data set, a shipment or RFT risk data set, and a shipment status message risk data set containing proof of delivery (POD) data. Each data set contains information relevant to a source of data used to identify a certain risk that must be normalized, integrated, and reconciled to unveil the risk. The data may include information associated with variables for each risk area. Also, each model may be generated using different model building techniques. However, each model may use the same scoring scale and the same scoring aggregation method to identify the dollar value of financial risk (risk value), as is further described below.

Each risk component may be represented by a base score as well as a factor representing source data, reference data, and input data that may serve to mitigate risk in certain areas. Source data represents transaction data from some external source that may augment the basic historical invoice data. Reference data represents master reference data, such as billing account numbers that may be required to measure certain risks. Input data enhancers represent input data normalization methods and modules, which may be applied to improve mitigation of certain risks. Embodiments of the model assign a correlation coefficient of risk to the presence or absence of relevant source data, reference data, and input data enhancers in the derivation of overall risk.

Embodiments of the duplicate billing risk scoring model may be used to identify risks of approving logistics charges that have been previously approved or paid. External source data from other payment processes may be necessary to identify risks associated with paying the same charges in different payment processes. Input data enhancers may be applied to ensure that invoices, shipments, and charges from different data sources are reconciled and recognized as being the same even when they contain different identifiers. For example, leading zeroes, prefixes, suffixes, and common keying errors on key identifiers can be normalized to ensure optimum ability to identify the same transactions in multiple data sources using a computer system.

Alternative controls are available to detect shipment-level duplicates. Shipment level duplicates may occur because a shipment may be identified using many different control numbers in any organization's logistics flow (e.g., freight bills, waybills, bills of lading, orders, etc.). Similarly, equipment identifiers, such as container numbers, trailer IDs, or railcar IDs may be used to detect shipment duplicates when shipment control numbers are different.

Embodiments of the non-company liability risk scoring model may be used to identify risks of approving logistics charges that the party receiving the invoice is not responsible to pay. External source data from RFTs and reference data indicating valid bill-to entities, including company names, addresses, billing account numbers, division codes, etc., must be available to ensure optimum ability to identify the responsible party for a logistics invoice transaction. Often, supply chain classifications related to origins, destinations, and shipment purposes, combined with international commercial terms—incoterms, if available, can offer additional confirmation that shipments are billed to the correct party. In global regions where tax is applicable, the process of validating tax charges may offer additional confirmation that the bill-to party on the invoice is correct.

Embodiments of the service validation risk scoring model may be used to identify risks that a service requested, billed, and delivered may not match when logistics based charges are dependent on specific services. When service guarantees are agreed upon between shippers and logistics service providers (LSPs), the risk of paying for shipments that do not meet the guarantee is identified. In other scenarios, the risk of being billed for services different than requested or actually delivered is highlighted separately. The risk of ghost shipments—i.e., paying an invoice for shipments that never occurred—can be measured and quantified when shipment and delivery documents are matched to invoices. Conversely, valid shipments for which no billing has been received raise the risk of under-reporting a liability that may occur in a future accounting period.

Many logistics invoices include charges for extra services above and beyond the base charges. These are known as accessorial charges in the industry. Correlation coefficients are available to identify cases when special charges are not applicable or were never requested. Examples include special day pickup/delivery, waiting time, and extra services. Similarly, certain residential or zone-based charges may be verified to ensure they are applicable based on agreed upon algorithms and shipment characteristics.

Embodiments of the charge validation risk scoring model may be used to identify risks of approving logistics charges that are billed either higher or lower than the calculated charges according to formal agreements between LSPs and shippers. This validation requires sophisticated technology to apply often-complex algorithms for determining correct charge amounts. The risk management system 104 is the foundation for determining the charge validation correlation coefficients that are based on a comparison of calculated amounts with billed amounts for each charge. Deficiencies (both overcharges and undercharges) highlight risks that billed amounts do not match the prices agreed upon.

Embodiments of the contract coverage controls focus on the determination of whether charges are covered by a valid agreement between shipper and LSP. Freight and accessorial charges are often based on some combination of the following variables: lane, service, weight/volume/quantity, equipment type, commodity, and activity date. Separate controls are applied to measure when failure to identify a contracted rate for a billed charge is based on a known deficiency in any variable listed above.

Period-based charges may also be dependent on identification of a rate for the applicable period (e.g., day, week, month, etc.). Charges based on an external index (e.g., fuel surcharge, currency conversion, or mileage) may be dependent on an agreed upon source for the external index. Separate controls identify when no source has been agreed upon, or when the agreed upon source does not provide a value for specific shipment circumstances.

A logistics rating engine within the risk management subsystem 104 of the logistics settlement execution system 101, calculates the expected price for logistics services based upon the contracts currently in force. In many cases the rating engine cannot determine a price due to missing or invalid data elements. These missing cases are reported separately in correlation coefficients designed to identify when required data for determining the correct rate has not been provided. In geographic areas where tax is applied to logistics charges, separate correlation coefficients may be configured to determine whether billed tax is applicable and billed at the appropriate rate based on legal requirements by region, country, and zone.

Continuing with FIG. 4, at 406, embodiments of the algorithm for determining the aggregation of risk components in the computation of an overall risk score and monetary value of this risk (risk value) is determined and updated. Each inherent risk component exists independently as an indication of risk in logistics settlement and can be measured and presented discretely. There may, however, be a hierarchy of risks applied for presentation purposes based on the combination of factors applied in relation to the logistics settlement profile. For example, a single invoice may have risks in multiple areas. From a practical standpoint, if an entire invoice is deemed to be a duplicate, there needs to be a level of reporting that excludes risks from other areas, only showing a single invoice, shipment or charge in one predominant category of risk to avoid double counting the same transactions. Otherwise charge and shipment level deficiencies on duplicated invoices would appear multiple times in the scoring, when the existence of these deficiencies at an invoice level as duplicates would prevent them from being processed more than once by the simplest of invoice level duplicate controls. As mentioned previously, the risk should be assessed for each risk component independently, the component scores may be aggregated through a union operation that merges and de-duplicates the sets of charges and the remaining risk may be allocated to triggered risk areas with the highest precedence based on the ordered control taxonomy represented in the control code numbering scheme.

At 407, the scoring models are calibrated. In this step the models are tuned to ensure that the output of the models (the model outcomes), are in the proper form and scale for presentation to users. The logistics settlement risk score is designed to range from 0 to 1000 and be presented in the basis point format familiar in the financial world. This presentation form allows a risk score to be easily multiplied by a spend number to produce a monetary value at risk (risk value). Based on the known values for spend for the profile scenario, a monetary risk value will also be presented at the risk component and aggregate level. In addition, any threshold values required are set to indicate threshold risk or risk value levels at this stage. Results should be valid for all levels of aggregation supported, from the overall enterprise level, to a range of transactions, and on down to an individual invoice or shipment. The validation should also confirm all stakeholder views and filters, such as those for LSPs, shippers, financial institutions, internal auditors, etc.

At 408, embodiments of the scoring models may be validated by evaluating the validation data set using the completed scoring models to confirm accuracy and precision. Validation may also protect against model over-fit, which is a condition where the model places more emphasis on a variable than might be found in the larger population of logistic settlement transactions in which the model would be run. By engaging in this step, an entity can gain confidence concerning the true effectiveness of the models in identifying logistics settlement risks outside of the modeling environment.

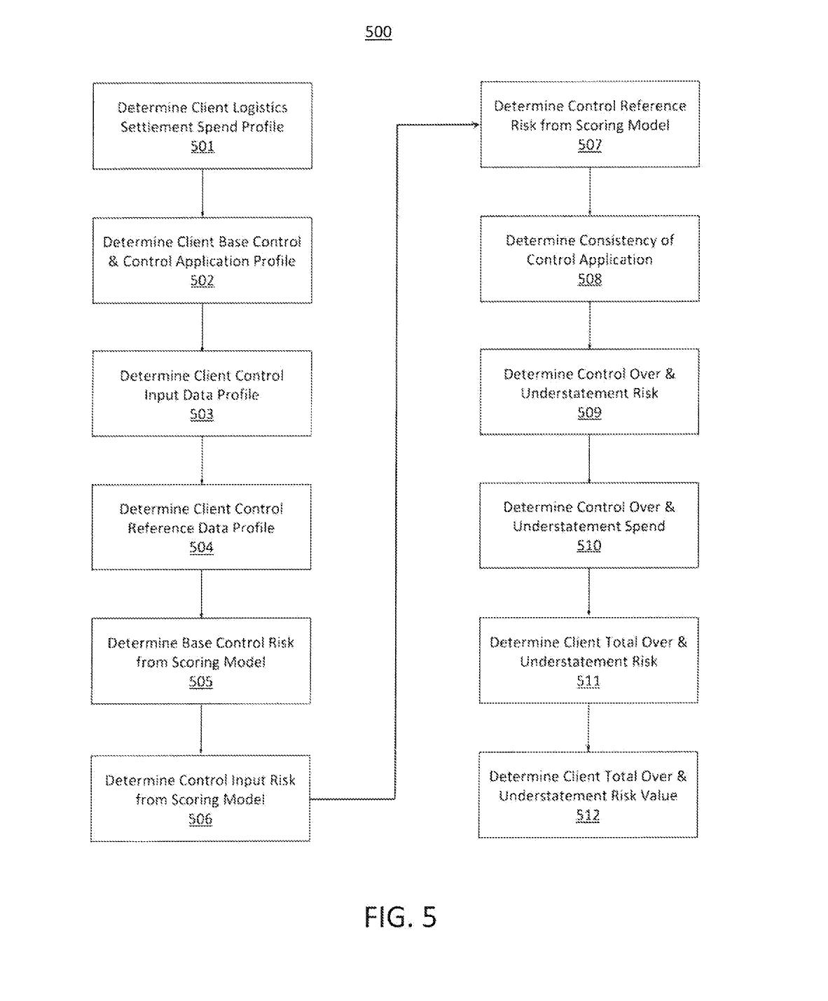

FIG. 5 illustrates a method 500 according to an embodiment for a logistics settlement risk scoring system 106. The method includes application of the risk scoring models to a logistics settlement profile to determine a logistics settlement risk score and monetary value of this risk (risk value). The method 500 and other methods and functions described herein may be performed by the logistics settlement risk scoring system 106 shown in FIGS. 1 and 2 by way of example. The methods may be performed in other systems as well.

Logistics settlement profiles may be evaluated using the scoring models to produce a risk score and monetary risk value, at any level of aggregation supported, including enterprise, transaction range, and individual shipment. Stakeholder views may be available by shipper, LSP, financial institution, and internal auditor. Logistics settlement profiles represent a combination of activity, which could be sourced either by actual transactions or estimated spending and control configuration, which could be sourced either by actual configuration master data or manual inputs.

The output may include determining a logistics settlement risk score for each individual profile presented. The same scoring scale (e.g., 0-1000) may be used for each application of a profile to the individual risk components represented. The calculation of risk value for each risk component will be performed by multiplying the risk score by the spend at risk for that component. Risk scores and risk value results will be aggregated based on the aggregation algorithm deployed in the latest version of the scoring model. Risks will be calculated and presented in a manner that conforms to the following relationship:

Inherent Risk Spend=Controls Spend+Control Risk Spend (Eq. 16)

The scoring model reports both under-statement and over-statement risks separately. Under-statement risks are cases where the amounts approved or reported in financial statements for certain risk categories may be less than expected. These amounts may represent material misstatements for financial reporting and contingent liabilities that may manifest themselves in a future accounting period. Over-statement risks are cases where amounts approved or reported in financial statements may be more than expected. These amounts may represent material misstatements for financial reporting and spending amounts higher than appropriate or correct.

At 501, the client logistics settlement spend profile is determined. Logistics settlement profiles capture the monetary value of spend activity, which could be sourced either by actual transactions or estimated spending. The profile will also indicate the stakeholder groups relevant for output, including shippers, LSPs, financial institutions, and internal auditors. The inputs of the profile will include an indication of the monetary value of spend for each risk component considered active for the current evaluation.

At 502, the client logistics base control and control application profile is determined. This configuration data could be sourced either by actual configuration master data or manual inputs. The inputs of the control application profile will include an indication of which specific risk components are configured for this evaluation.

At 503, the client control input data profile is determined. This configuration data could be sourced either by actual configuration master data or manual inputs. The inputs of the profile will include an indication of which input data enhancers are configured for each risk component. Input data enhancers are data normalization routines that improve the performance of controls for certain risk components. The scoring model assigns a risk score based on the presence or absence of each individual input data enhancer.

At 504, the client control reference data profile is determined. This configuration data could be sourced either by actual configuration master data or manual inputs. The inputs of the profile will include an indication of which reference data enhancers are configured for each risk component. Reference data enhancers are master data tables that improve or enable the performance of controls for certain risk components. The scoring model assigns a risk score based on the presence or absence of each individual reference data enhancer.

At 505, the base control risk is determined for each risk component by gathering the base control risk score for each risk component enabled. When the activity data is sourced by actual transactions and the financial control is enabled for this evaluation, the base control risk score is determined dynamically by calculating the correlation coefficient based on actual results. For this calculation, the actual predicted spend is divided by the actual predictive spend. When the logistics settlement profile is sourced by estimates, or the risk component is not enabled, the risk score is derived from the scoring model.

At 506, the control input risk is determined for each risk component by gathering the control input risk score for each risk component enabled. When the activity data is sourced by actual transactions, and the financial control is enabled for this evaluation, the control input risk score is determined dynamically by calculating the correlation coefficient based on actual results. For this calculation, the actual predicted spend is divided by the actual predictive spend. When the activity data is sourced by estimates, or the risk component is not enabled, the risk score is derived from the scoring model.

At 507, the control reference risk is determined for each risk component by gathering the control reference risk score for each risk component enabled. When the activity data is sourced by actual transactions and the financial control is enabled for this evaluation, the control reference risk score is determined dynamically by calculating the correlation coefficient based on actual results. For this calculation, the actual predicted spend is divided by the actual predictive spend. When the activity data is sourced by estimates, or the risk component is not enabled, the risk score is derived from the scoring model.

At 508, the consistency of control application is determined for each risk component. This is performed by gathering the consistency of control percentage for each risk component enabled. This feature enables adjustment of the assessed level of effectiveness of the control in the current environment; when a control is known to only be applied to a portion of the total predictive spend. For example, a control that is applied manually may be known to be ineffective based on manual checking. In another case, a control that requires matching to RFTs may only apply to part of the total spend input. This percentage is always input manually into the client base control and control application profile based on client assessment.

At 509, the control over- and under-statement risk is determined for each risk component, and is performed by aggregating all the individual component risk scores in the over- and under-statement sub-categories.

At 510, the control over- and under-statement monetary risk value is determined for each risk component, and is performed by multiplying all the individual component risk scores in the over- and under-statement sub-categories by the predictive spend associated with the control to arrive at the monetary risk value for each configured risk component.

At 511, the client total over- and under-statement risk is determined by aggregating all the individual control over- and understatement risk scores as determined in 509 above according to the aggregation algorithms established in embodiments of the scoring model.

At 512, the client total over- and under-statement monetary risk value is determined by aggregating all the individual control over- and under-statement risk value amounts as determined in 510 above according to the aggregation algorithms established in the scoring model.

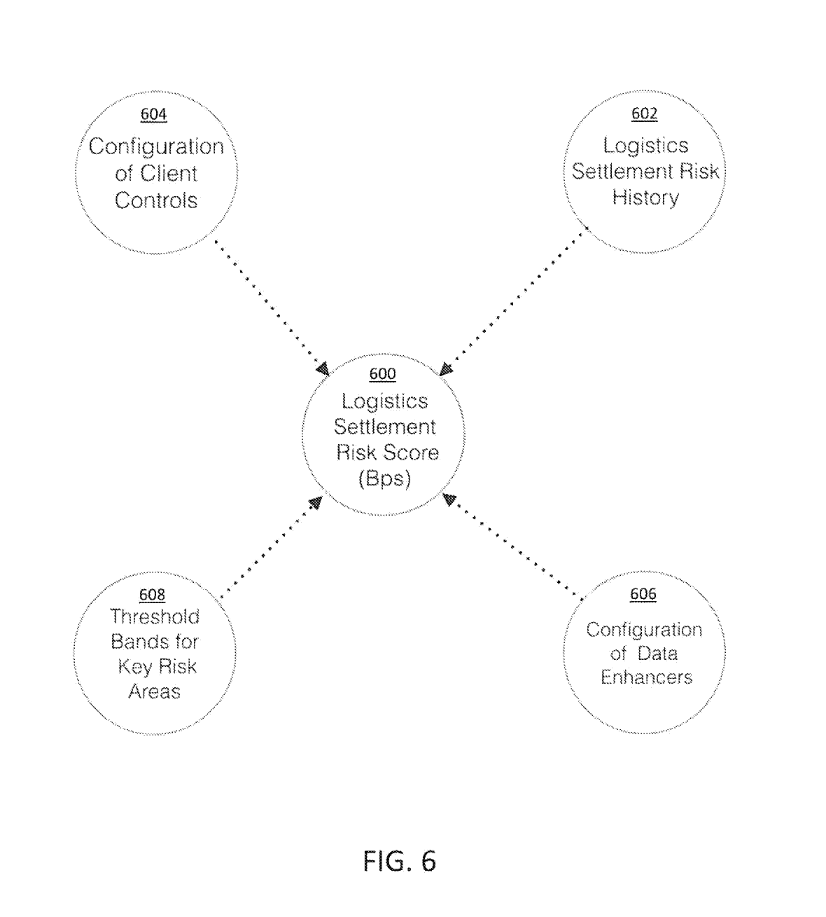

FIG. 6 is a schematic representation of the logistics settlement risk score 600, showing the different sources of input for the calculation of the risk score. The starting point is the logistics settlement risk history 602 which is an accumulation of the occurrences of each type risk and its impact expressed as basis points of the spend at risk. The history includes a broad spectrum of companies and industries with different controls configurations, meaning none, some, or all of the controls may be in place. In addition, these customers may have none, some, or all of the data enhancers in place. This ensures rich and detailed data on the occurrence of risk, and the success of different methods and configurations in mitigating that risk. This information alone can provide useful information on the likelihood of the occurrence of any given deficiency within any transaction or group of transactions before consideration is given to the mitigation of the risks and the quality of the controls put in place by the company.

The configuration of the client controls 604 is then applied to the logistics settlement risk history 602 to produce a more accurate assessment of the client risk as described in 502. This can be achieved through an interview and completion of a questionnaire detailing the existence and configuration of controls within the client process or through live data from the logistics settlement execution system.

Data enhancers 606 may then be added to the configuration of the client controls as described in 503 and 504 as the control data profiles. This adds to the detail supporting the quality of the controls in place allowing further refinement of the risk score for each component based on whether the data enhancer is in place.

Finally, the resulting component risk scores are aggregated and sorted into their ranking within the top, middle and lower bandings 608 of their peer group results.

In an additional embodiment, the logistics settlement risk scoring system may be implemented in an integrated spreadsheet model. In the integrated spreadsheet model, a data repository is realized as data embedded in a spreadsheet application file. The client profile input data is collected via an interview with the client or examination of historical data to answer questions presented in a spreadsheet application worksheet. In this embodiment, the risk component identifier module is realized through analysis of the historical data in the data repository. In addition, the risk scoring models are developed through additional analysis and represented in a spreadsheet application worksheet. The dashboard module is represented as a reporting framework implemented in a spreadsheet application worksheet. The application integration and communication layer module is manifest through the application programming interface (API) native to the spreadsheet application program. The integrated spreadsheet model embodiment can be implemented on many forms of computation devices including desktop computers, internet-based systems, mini/mainframe systems, tablets and smart phones. The risk component and aggregation algorithms are executed by the application of formulas and routines within the integrated spreadsheet model.

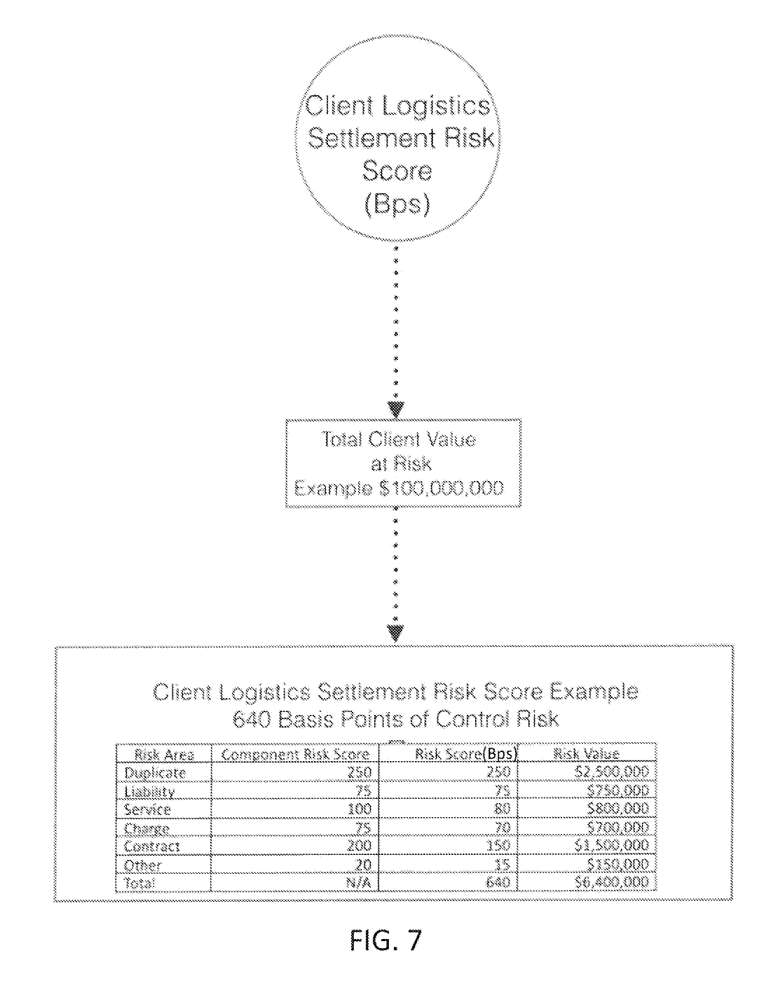

FIG. 7 shows an example of the application of a calculated logistic settlement risk score to a client logistics settlement profile according to an embodiment of the invention. In the example of FIG. 7, the client logistics settlement risk score is applied to the client logistics spend to give a detailed monetary estimate of the control risk remaining in the process, location, or collection of transactions being considered. The diagram is a simplification of the more detailed risk assessment which records and measures the risk at a more detailed, component level. This representation is of the calculated risk in each major risk area in total as well as the aggregated net score and the estimated risk value from each major risk area. In the example the client has a logistic spend of 100 million dollars. The total risk score of 640 basis points is determined from the component risk scores after duplication of risk elements have been removed or filtered out. Taking the risk score of 640 basis points (Bps) (6.4%) and multiplying by the client logistic spend of 100 million dollars results in a risk value of 6.4 million dollars.

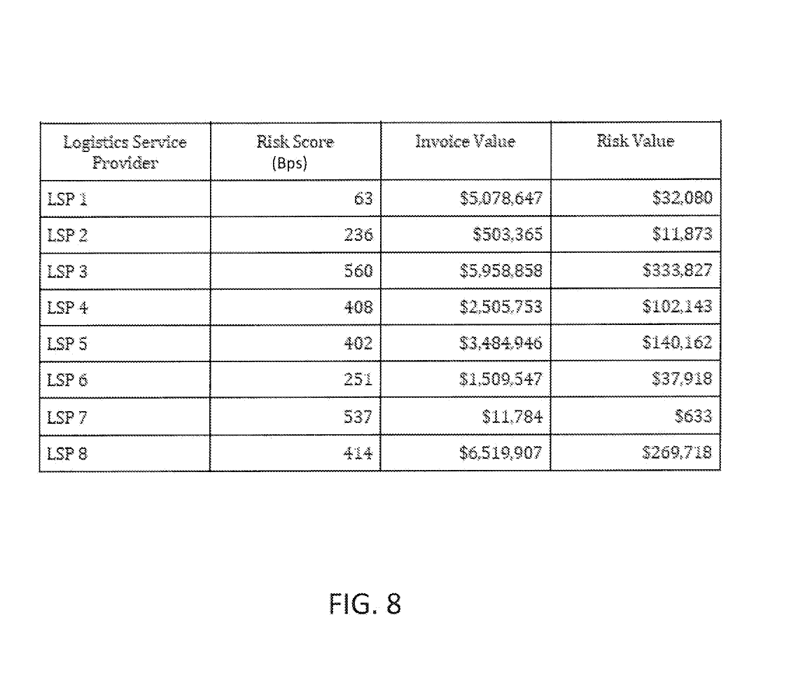

FIG. 8 is a table showing the application of calculated logistics settlement risk scores to transportation invoices grouped by LSP according to an embodiment of the invention. In the example of FIG. 8, specific client logistic settlement risk scores are applied to each LSP to illustrate the differing risk in groups of invoices payable to different LSPs. This is then applied to the value of these invoices to arrive at the total dollar value of risk (risk value) for these invoices.

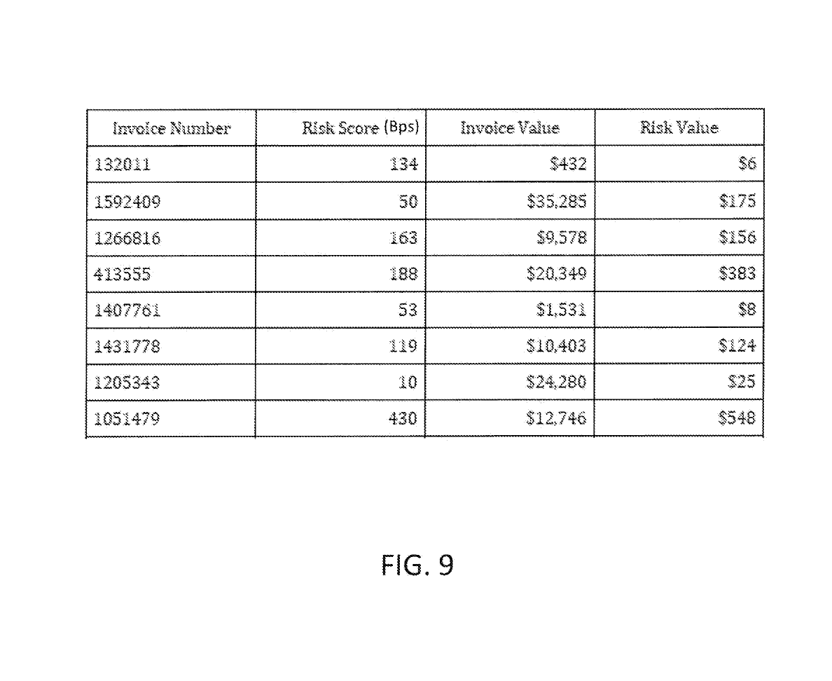

FIG. 9 is a table showing the application of a calculated logistics settlement risk score to individual invoices according to an embodiment of the invention. In the example of FIG. 9, the risk value calculation is shown at a lower level, this time at an actual invoice level, and effectively calculates the expected risk within each invoice in financial terms. The calculation is based on the control configuration within the client logistics settlement profile as applied to each invoice.

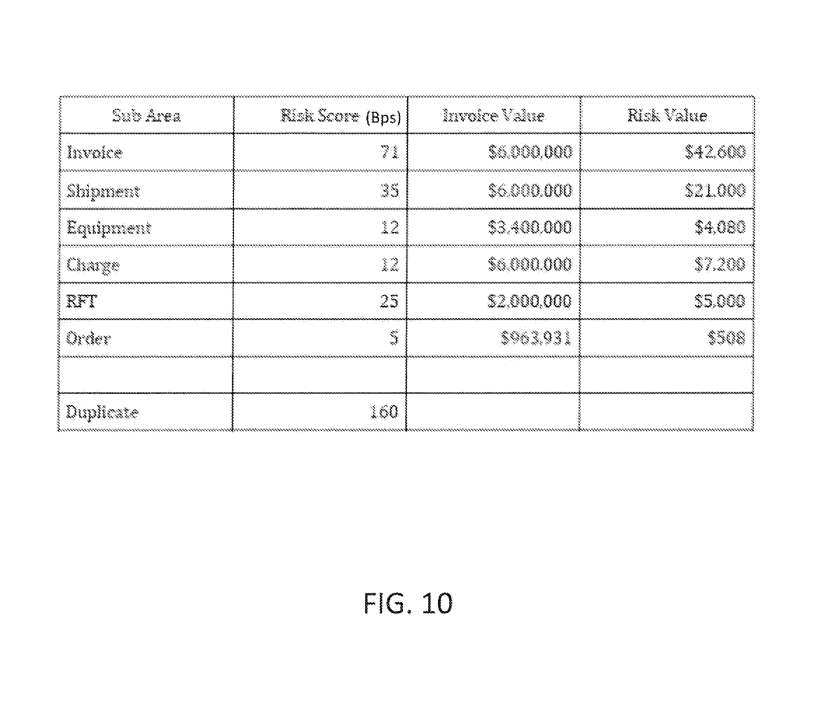

FIG. 10 is a table showing a lower level detail of the ‘duplicate’ risk area with details of risk in each sub-area according to an embodiment of the invention. In the example shown in FIG. 10, a breakdown of the main risk area ‘Duplicates’ is displayed, and indicates the basis points of risk in each of the sub areas of risk and applies the basis points of risk to the monetary value of the invoices that contain characteristics which make them susceptible to the occurrence of this type of risk. Note that this amount differs according to the value of invoices that might contain that type of risk. As an example, equipment duplicates, will not be present in transactions that do not use, require, or contain charges for specific equipment and as a result, the value of invoices with the potential for equipment duplicate risk is lower than for some of the other more generic risks.

The foregoing description is illustrative of particular embodiments of the invention, but is not meant to be a limitation upon the practice thereof. The following claims, including all equivalents thereof, are intended to define the scope of the invention.

1. A computerized method for generating a risk scoring model to predict risk in a logistics settlement process, said method comprising:
determining a set of model outcomes in the form of a set of predicted variables, said set of model outcomes representing high-risk in said logistic settlement process;
interfacing with one or more data sources over a network to receive logistics settlement data;
creating a data structure in a data storage device to store at least some of said logistics settlement data;
creating one or more model building data sets, wherein said one or more model building data sets are derived from said stored logistics settlement data;
storing said one or more model building sets in said data structure;
determining one or more risk components in the form of a set of predictive variables, said one or more risk components representing high risk in said logistics settlement process;
determining control effectiveness in the form of a set of correlation coefficients categorized into risk areas to quantify a correlation between said set of model outcomes and said one or more risk components which is used to calculate a component risk score; and
determining a score aggregation algorithm.

2. The method of claim 1 further comprising calibrating said generated risk models by determining a scoring scale to use for each of said one or more risk components and a set of score thresholds that indicate various risk bands.

3. The method of claim 1 further comprising validation of said scoring models by evaluating a validation data set using the completed version of said risk scoring models to confirm model accuracy and precision on a set of one or more logistics settlement profiles comprised of one or more invoice batches, each of said one or more invoice batches ranging in size from a plurality of invoices down to an individual invoice.

4. The method of claim 1 wherein said one or more model building data sets comprise at least one of a training data set or a validation data set.

5. The method of claim 1 wherein said determining of said one or more risk components is with a set of advanced analytic techniques, said set of techniques comprising at least one of logistic regression, machine learning, multi-dimensional polymorphism, quantum state machines, decision trees, data mining regression, and bootstrapping and ensemble.

6. The method of claim 1 wherein said determining of said control effectiveness further comprises:
developing a plurality of scoring models utilizing said risk components and said control effectiveness measures for each distinct risk from said one or more risk components; and
wherein said one or more risk components comprise at least one of duplicate billing, non-company liability, service validation, charge validation, contract coverage, and shipper payment propensity models.

7. The method of claim 1 wherein said determining of said control effectiveness further comprises:
determining at least one of a base risk control effectiveness, a source data control effectiveness, a reference data control effectiveness, and an input data enhancers control effectiveness for each risk component of said one or more risk components.

8. The method of claim 1 wherein said score aggregation algorithm is formed by a mathematical union of said one or more risk components.

9. The method of claim 1 wherein said determining of said score aggregation algorithm comprises an allocation of merged and de-duplicated risk component risk scores to risk areas with the highest precedence based on an ordered control taxonomy.

10. An automated logistics settlement risk scoring system, said system comprising:
a computer system configured with one or more processors for implementation of:
an application integration and communication layer configured to interface with one or more data sources over a network to obtain a series of logistics settlement data;
a data repository to store one or more model building data sets determined from said series of logistics settlement data;
a profile collector module configured to capture a logistics scenario to be evaluated, where said logistics scenario comprises logistics activity levels and a logistics settlement financial controls configuration;
a risk component identifier configured to identify a set of characteristics of a logistics settlement process that correlate to a settlement risk;
a model generator configured for generation of one or more risk scoring models;
a risk analysis module configured to evaluate one or more batches of invoices within said logistics settlement process, where the evaluation is based on said one or more risk scoring models to determine a set of logistics settlement risks scores and a set of monetary risk values; and
a dashboard module.

11. The system of claim 10 wherein said logistics scenario is based on a profile estimated and captured via an interview.

12. The system of claim 10 wherein said logistics scenario is based on a profile collected in real-time from a logistics settlement execution system.

13. The system of claim 10 wherein said risk component identifier employs statistical analysis or machine learning techniques to identify one or more risk components from said set of characteristics.

14. The system of claim 13 wherein said statistical analysis techniques comprise one or more of a cross-tab analysis, a factor/cluster analysis and principal component analysis (PCA), multiple regression, and analysis of variance/analysis of covariance (ANOVA/ANCOVA).

15. The system of claim 13 wherein said one or more risk components comprise a series of variables, said variables further comprising:
one or more of a duplicate billing risk, a non-company liability risk, a service validation risk, a charge validation risk, a contract coverage risk, and a shipper payment propensity risk.

16. The system of claim 10 wherein said risk component identifier employs machine learning techniques, such as multi-dimensional polymorphism and quantum state machines to identify one or more risk components.

17. The system of claim 16 wherein said one or more risk components comprise a series of variables, said variables further comprising:
one or more of a duplicate billing risk, a non-company liability risk, a service validation risk, a charge validation risk, a contract coverage risk, and a shipper payment propensity risk.

18. The system of claim 10 wherein said one or more risk scoring models are generated using a series of statistical analysis techniques, said statistical analysis techniques further comprising:
one or more of logistic regression, business rules, or other model building techniques based on a set of derived risk components from said set of characteristics and other variables.

19. The system of claim 10 wherein said one or more risk scoring models comprise one or more of models for logistics settlement duplicate billing, non-company liability risk, service validation, charge validation, contract coverage, and shipper payment propensity risk.

20. The system of claim 10 wherein each derived score from said set of logistics settlement risks scores is on a predetermined scoring scale, compared to a set of scoring thresholds and sorted into a set of risk bands.

21. The system of claim 10 wherein said risk analysis module determines one or more of duplicate billing, non-company liability, service validation, charge validation, contract coverage, and shipper payment propensity risk scores.

22. The system of claim 10 wherein said dashboard further comprises a graphical user interface to provide illustrations of one or more of duplicate billing, non-company liability, service validation, charge validation, contract coverage, and shipper payment propensity risk.

23. The system of claim 22 wherein said dashboard provides the ability for drill downs, all the way to an individual invoice or shipment level to display additional information; and
wherein said additional information is used to describe or define at least one of a risk profile, spend at risk, root causes, and corrective actions.

24. A computerized method for evaluating a set of logistics settlement profile scenarios, said method comprising:
determining a logistics settlement spend profile;
determining a set of risk components;
determining a base control profile and a control application profile to indicate which individual controls from said set of controls are configured for the evaluation of said set of logistic settlement profile scenarios and how consistently said individual controls are applied during the evaluation;
determining an input data profile, said input data profile used to select which individual input data enhancers from a set of data enhancers are configured for each individual risk component from said set of risk components, wherein said individual input data enhancers are utilized for control of input normalization;
determining a reference data profile, said reference data profile used to select which individual reference data enhancers from said set of data enhancers, and which master data tables from a set of master data tables are configured for each of said individual risk component from said set of risk components;
determining a base control risk for each of said individual risk component from said set of risk components;
determining a control input risk for each of said individual risk component from said set of risk components;
determining a control reference risk for each of said individual risk component from said set of risk components;
determining a control over and understatement risk score for each individual risk component from said set of risk components by aggregating one or more sub-components of risk for each individual risk control from a set of risk controls;
determining a control over and understatement risk value by multiplying a risk score in basis points for each of said individual risk component from said set of risk components by a predictive spend associated with a corresponding individual risk control from said set of risk controls;
determining a client total over and understatement risk by aggregating all of said individual control over and understatement risk scores according to one or more aggregation algorithms in a scoring model;
determining a client total over and understatement risk value by aggregating all of said individual control over and understatement risk values according to said one or more aggregation algorithms in said scoring model; and
presenting said client total over and understatement risk and said client total over and understatement risk value as tabular information with a graphical user interface (GUI) displayed on a dashboard.

25. The method of claim 24 wherein said logistics settlement profile scenarios are based on one or more logistics settlement risk scoring models that identify risk scores and monetary risk values associated with said logistics settlement profile scenarios under evaluation.

26. The method of claim 24 wherein said logistics settlement spend profile comprises a monetary value of logistics spend by category and can be sourced either by actual live transactions or estimated spending via a client interview.

27. The method of claim 24 wherein said base control and control application profile is configured based on a first set of configuration data; and
wherein said first set of configuration data is sourced either by actual configuration master data from a risk settlement execution system or via manual inputs to a computer running said computerized method of claim 24.

28. The method of claim 24 wherein said input data profile is configured based on a second set of configuration data; and
wherein said second set of configuration data is sourced either by actual configuration master data from a risk settlement execution system or via manual inputs to a computer running said computerized method of claim 24.

29. The method of claim 24 wherein said master data tables improve or enable the performance of said set of controls.

30. The method of claim 24 wherein said reference data profile is configured based on a third set of configuration data; and
wherein said third set of configuration data is sourced either by actual configuration master data from a risk settlement execution system or via manual inputs to a computer running said computerized method of claim 24.

31. The method of claim 24 wherein said base control risk for each of said individual risk component from said set of risk components is based on a correlation coefficient that is dynamically calculated when a profile is derived from a set of actual transactions from a logistics settlement execution system; and
wherein said correlation coefficient is derived from said scoring models when a logistics settlement profile is sourced through estimates via a client interview.

32. The method of claim 24 wherein said control input risk for each of said individual risk component from said set of risk components is based on a correlation coefficient that is dynamically calculated when a profile is derived from a set of actual transactions from a logistics settlement execution system; and
wherein said correlation coefficient is derived from said scoring models when a logistics settlement profile is sourced through estimates via a client interview.

33. The method of claim 24 wherein said control reference risk for each of said individual risk component from said set of risk components is based on a correlation coefficient that is dynamically calculated when a profile is derived from a set of actual transactions from a logistics settlement execution system; and
wherein said correlation coefficient is derived from said scoring models when a logistics settlement profile is sourced through estimates via a client interview.

34. The method of claim 24 further comprising a consistency of control application to account for the reduced effectiveness of a control from said individual controls when the control is not consistently applied.

35. The method of claim 24 wherein said tabular information is selectable for drill-down via the GUI all the way to an individual invoice or shipment level to display additional information describing risk profile, spend at risk, root causes, and corrective actions.
